(19) United States
(12) Patent Application Publication
(10) Pub. No.: US 2026/0097891 A1
(43) Pub. Date: Apr. 9, 2026

(54) FOLDABLE PACKAGING INSERT COMPRISING MULTIPLE CELLULOSE-BASED AIR-LAID OR SOLID FOAM SUBSTRATES

(71) Applicant: Stora Enso OYJ, Helsinki (FI)

(72) Inventors: Martin Malmqvist, Halmstad (SE); Lars Persson, Örby (SE)

(73) Assignee: Stora Enso OYJ, Helsinki (FI)

(21) Appl. No.: 19/103,947

(22) PCT Filed: Jul. 13, 2023
(86) PCT No.: PCT/IB2023/057179

§ 371 Date: Feb. 14, 2025

(30) Foreign Application Priority Data
Sep. 23, 2022 (SE) 2230308-5

(51) Int. Cl. B65D 81/127; B26D 3/02; B65D 81/38

(52) U.S. Cl. CPC B65D 81/127; B26D 3/02; B65D 81/3858; B65D 81/3862; B65D 2581/053

(57) ABSTRACT

A packaging insert (10) comprises multiple cellulose-based air-laid or solid foam substrates (20, 20A, 20B, 20C) having respective first and second main sides (22, 22A, 22B, 22C, 24, 24A, 24B, 24C). The packaging insert (10) also comprises a first paper-based sheet (30) attached to the first main sides (22, 22A, 22B, 22C) and a second paper-based sheet (40) attached to the second main sides (24, 24A, 24B, 24C). Edges (26, 26A, 26B, 28, 28B, 28C) of consecutive cellulose-based air-laid or solid foam substrates (20, 20A, 20B, 20C) facing each other are beveled edges (26, 26A, 26B, 28, 28B, 28C) and form an angle (a) between each other that is less than 90°. At least one hinge section (50, 50A, 50B) is interposed between the beveled edges (26, 26A, 26B, 28, 28B 28C) of the consecutive cellulose-based air-laid or solid foam substrates (20, 20A, 20B, 20C). The packaging insert (10) is foldable in the hinge section(s) (50, 50A, 50B) and can be positioned within a packaging (80) to protect packaged goods. The invention also relates to a method of producing a packaging insert (10).

### TECHNICAL FIELD

The present invention generally relates to packaging inserts, and in particular to such packaging inserts suitable for protecting packaged goods from shock impact and/or for thermal insulation of packaged goods.

### BACKGROUND

With growing awareness for the environment and humanly induced climate change, the use of plastic insulation and/or cushioning products has come more and more into question. However, despite this concern the use of these products has grown vastly with new trends in lifestyles and consumer habits of the last decade. One reason for this is that more and more goods are transported around the globe and these goods need protection against impact or shock and/or extreme temperatures. A common way of protecting the goods is to include cushioning and/or insulating products, such as inserts of suitable form into the packaging. These can be made from different materials but are typically made from a foamed polymer, of which expanded polystyrene (EPS) is by far cheapest and most common. In some cases, the entire packaging can be made out of EPS. EPS is, however, one of the most questioned plastic materials and many brand owners are looking for more sustainable solutions for these packaging applications.

U.S. Pat. No. 10,787,303 discloses packaging insulation for insertion into a packaging container, which includes an air laid natural fibrous batt having foldable paper sheet material adhered to both sides of the batt. US 2021/0061542 discloses an insulation packaging assembly comprising a box defining a box cavity that includes an insulation liner. The insulation liner is disclosed to be made of polyethylene terephthalate (PET), polyethylene, polyurethane or polypropylene. A biodegradable insulation liner could be made of recycled cotton.

U.S. Pat. No. 10,625,918 discloses a foldable and biodegradable cushioning sheet comprising a flexible base film and a plurality of cushions located on the top surface of the flexible base film. The cushioning sheet can be folded one-way to provide a sturdy inside corner.

A shortcoming with the inserts of the prior art is that they are not easily folded when placed inside a box or container due to the thickness of the insulating material of the insert. There is therefore a need for improved packaging inserts that can be easily folded to fit into boxes or containers and therein used for protecting goods from shock impact and/or for thermal insulation of packaged goods.

### SUMMARY

It is a general objective to provide a packaging insert for protecting goods from shock impact and/or for thermal insulation of packaged goods.

It is a particular objective to provide a foldable packaging insert.

These and other objectives are met by embodiments as disclosed herein.

The present invention is defined in the independent claims. Further embodiments of the invention are defined in the dependent claims.

An aspect of the invention relates to a packaging insert comprising multiple cellulose-based air-laid or solid foam substrates having a respective first main side and a second main side opposite to the first main side. The packaging insert also comprises a first paper-based sheet attached to the first main sides of the multiple cellulose-based air-laid or solid foam substrates and a second paper-based sheet attached to the second main sides of the multiple cellulose-based air-laid or solid foam substrates. Edges of consecutive cellulose-based air-laid or solid foam substrates of the multiple cellulose-based air-laid or solid foam substrates facing each other are beveled edges and form an angle between each other that is less than 90°. At least one hinge section is interposed between the beveled edges of the consecutive cellulose-based air-laid or solid foam substrates. The packaging insert is foldable in the at least one hinge section.

Another aspect of the invention relates to a packaging assembly comprising a packaging comprising a bottom and multiple side walls defining a cavity. The packaging assembly also comprises a packaging insert according to above positioned within the cavity.

A further aspect of the invention relates to a method for producing a packaging insert. The method comprises cutting a cellulose-based air-laid or solid foam substrate blank at an angle of less than 45° relative to a normal of a main side of the cellulose-based air-laid or solid foam substrate blank and at a second angle equal to but of opposite sign to the first angle to obtain at least a first cellulose-based air-laid or solid foam substrate comprising a beveled edge, a second cellulose-based air-laid or solid foam substrate comprising two beveled edges and a third cellulose-based air-laid or solid foam substrate comprising a beveled edge. The method also comprises turning the second cellulose-based air-laid or solid foam substrate upside down so that the beveled edge of the first cellulose-based air-laid or solid foam substrate faces a first beveled edge of the second cellulose-based air-laid or solid foam substrate and the beveled edge of the third cellulose-based air-laid or solid foam substrate faces a second beveled edge of the second cellulose-based air-laid or solid foam substrate. The beveled edge of the first cellulose-based air-laid or solid foam substrate and the first beveled edge of the second cellulose-based air-laid or solid foam substrate form an angle between each other that is less than 90°. The beveled edge of the third cellulose-based air-laid or solid foam substrate and the second beveled edge of the second cellulose-based air-laid or solid foam substrate form an angle between each other that is less than 90°. The method further comprises attaching a first paper-based sheet to first main sides of the at least first, second and third cellulose-based air-laid or solid foam substrates and a second paper-based sheet to second main sides of the at least first, second and third cellulose-based air-laid or solid foam substrates to form the packaging insert. The packaging insert comprises a first hinge section interposed between the beveled edge of the first cellulose-based air-laid or solid foam substrate and the first beveled edge of the second cellulose-based air-laid or solid foam substrate. The packaging insert also comprises a second hinge section interposed between the second beveled edge of the second cellulose-based air-laid or solid foam substrate and the beveled edge of the third cellulose-based air-laid or solid foam substrate.

The packaging insert is designed to be foldable but still efficiently protect goods from shock impact and/or for thermal insulation. The packaging insert can be folded and thereby fit well into various packaging, boxes and containers, but without any significant compromise of the cushioning or insulation capacity of the packaging inserts at the folds. This is possible by having consecutive or neighboring cellulose-based air-laid or solid foam substrates with beveled edges forming an angle that is less than 90°. The beveled edges facing each other constitutes a hinge section. The packaging insert is then easily folded at the hinge section and designed so that when folded at the hinge section, consecutive cellulose-based air-laid or solid foam substrates may be positioned next to or adjacent each other and provide cushioning and insulation also at the folds.

### BRIEF DESCRIPTION OF THE DRAWINGS

The embodiments, together with further objects and advantages thereof, may best be understood by making reference to the following description taken together with the accompanying drawings, in which:

FIG. 1 is a cross-sectional view of a packaging insert according to an embodiment;

FIG. 2 is a cross-sectional view of a packaging insert according to another embodiment;

FIG. 3 is a cross-sectional view of a packaging insert according to a further embodiment;

FIGS. 4A to 4D schematically illustrates an embodiment of producing a packaging insert.

FIG. 5 illustrates a packaging assembly comprising a packaging insert according to an embodiment;

FIG. 6 illustrates a packaging assembly comprising a packaging insert according to an embodiment;

FIG. 7 is a close-up of a portion of the packaging assembly shown in FIG. 6;

FIG. 8 is a flow chart illustrating a method of producing a packaging insert according to an embodiment; and

FIG. 9 is a view from above of the packaging insert shown in a cross-sectional view in FIG. 3.

### DETAILED DESCRIPTION

The present invention generally relates to packaging inserts, and in particular to such packaging inserts suitable for protecting packaged goods from shock impact and/or for thermal insulation of packaged goods.

The packaging inserts of the present embodiments are useful as environmentally more friendly replacements to corresponding packaging inserts made of or from foamed polymers, for instance expanded polystyrene (EPS). There are packaging inserts made of environmentally friendly materials, such as recycled cotton as disclosed in U.S. Pat. No. 10,787,303 and US 2021/0061542. These packaging inserts are said to be foldable, however, the thickness of the packaging inserts imply that they are not easily folded to fit into corners of various packaging, boxes and containers without significant compression of the packaging inserts at the fold. This compression at the folds in turn means that the packaging inserts are less effective in protecting goods from shock impact at the compressed folds. Furthermore, if the packaging inserts are intended to provide thermal insulation for tempered or cold goods, the compressed folds constitute vulnerable sections where the thermal insulation capacity of the packaging inserts is lower.

The packaging inserts of the present embodiments are designed to be foldable but still efficiently protect goods from shock impact and/or for thermal insulation. This means that the packaging inserts can be folded and thereby fit well into various packaging, boxes and containers, but without any significant compromise of the cushioning or insulation capacity of the packaging inserts at the folds. This is possible by having consecutive cellulose-based air-laid or solid foam substrates with beveled edges forming an angle between each other that is less than 90°. A hinge section is interposed between the beveled edges facing each other. The packaging insert is then easily folded at the hinge section and designed so that when folded at the hinge section, consecutive cellulose-based air-laid or solid foam substrates will be next to or adjacent each other and provide cushioning and insulation also at the folds.

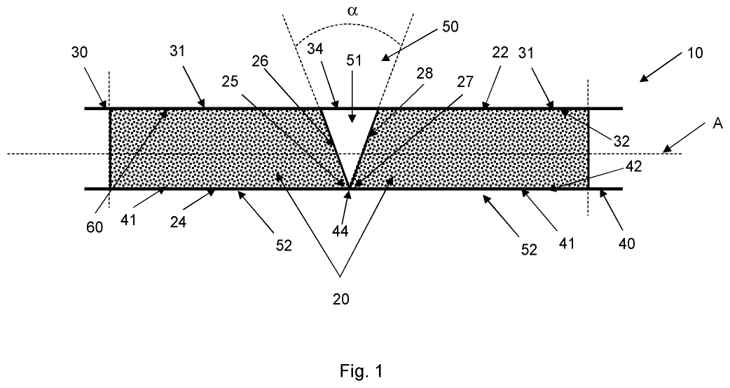

FIG. 1 illustrates a packaging insert 10 according to an embodiment. The packaging insert 10 comprises multiple, i.e., at least two, cellulose-based air-laid or solid foam substrates 20 having a respective first main side 22 and a second main side 24 opposite to the first main side 22. The packaging insert 10 also comprises a first paper-based sheet 30 attached to the first main sides 22 of the multiple cellulose-based air-laid or solid foam substrates 20 and a second paper-based sheet 40 attached to the second main sides 24 of the multiple cellulose-based air-laid or solid foam substrates 20. Edges 26, 28 of consecutive cellulose-based air-laid or solid foam substrates 20 of the multiple cellulose-based air-laid or solid foam substrates 20 facing each other are beveled edges 26, 28. These beveled edges 26, 28 form an angle a between each other that is less than 90°. The packaging insert 10 comprises at least one hinge section 50 interposed between the beveled edges 26, 28 of the consecutive cellulose-based air-laid or solid foam substrates 20. The packaging insert 10 is then foldable in the at least one hinge section 50.

As is shown in FIG. 1, the multiple cellulose-based air-laid or solid foam substrates 20 are sandwiched between the first and second paper-based sheets 30, 40 and thereby form multiple sandwich sections 52. The packaging insert 10 further comprises at least one hinge section 50 interposed between adjacent sandwich sections 52 of the multiple sandwich sections 52. Thus, a respective hinge section 50 is provided between two consecutive sandwich sections 52. The packaging insert 10 is then easily foldable in or at the at least one hinge section 50.

The packaging insert 10 comprises multiple separate cellulose-based air-laid or solid foam substrates 20, also referred to as panels herein. These multiple cellulose-based air-laid or solid foam substrates 20 are separated from each other and thereby constitute separate substrates or panels 20. The multiple cellulose-based air-laid or solid foam substrates 20 are arranged one after another along a longitudinal axis A passing through the multiple cellulose-based air-laid or solid foam substrates 20. The multiple cellulose-based air-laid or solid foam substrates 20 are held together by the first and second paper-based sheets 30, 40 attached to the first and second main sides or surfaces 22, 24 of the multiple cellulose-based air-laid or solid foam substrates 20. The packaging insert 10 will thereby comprise so-called sandwich sections 52, at which the multiple cellulose-based air-laid or solid foam substrates 20 are sandwiched between the first and second paper-based sheets 30, 40. Each such sandwich section 52 thereby comprises a cellulose-based air-laid or solid foam substrate 20 interposed between the two paper-based sheets 30, 40. Consecutive sandwich sections 52 in the packaging insert 10 are separated from each other by a respective hinge section 50. The hatched lines in FIG. 1 separates the sandwich sections 52 and the hinge section 50.

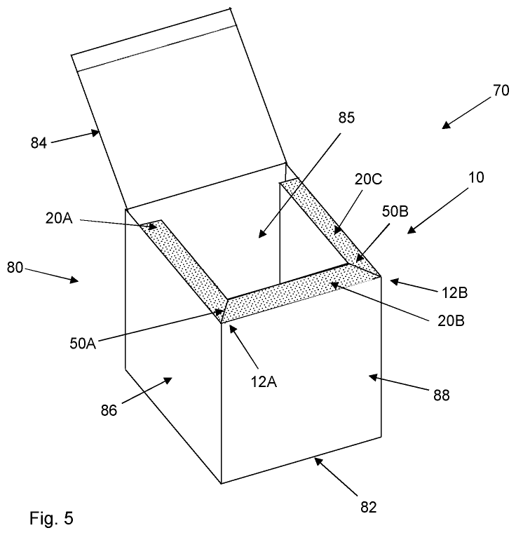

The multiple cellulose-based air-laid or solid foam substrates 20 are, as shown in FIG. 1, comparatively thicker as compared to the two paper-based sheets 30, 40. The cellulose-based air-laid or solid foam substrates 20 thereby provide the cushioning and/or insulation ability of the packaging insert 10. This comparatively large thickness of the cellulose-based air-laid or solid foam substrates 20 imply that they are not readily folded without causing a significant compression of the cellulose-based air-laid or solid foam substrates 20. The comparatively thinner paper-based sheets 30, 40 are, however, readily foldable. This means that the packaging insert 10 can easily be folded at the one or more hinge sections 50 to be packable in a packaging 80, see FIGS. 5 to 7, without any significant compression of the cellulose-based air-laid or solid foam substrates 20, even at the corners 12A, 12B of the packaging 80.

In an embodiment, an average thickness of each of the multiple cellulose-based air-laid or solid foam substrates 20 is preferably at least 10 times larger than an average thickness of each of the two paper-based sheets 30, 40, preferably at least 15 times, such as at least 20 times, at least 25 times, or at least 30 times larger than an average thickness of the two paper-based sheets 30, 40. In a particular embodiment, the average thickness of each of the multiple cellulose-based air-laid or solid foam substrates 20 is preferably at least 50 times larger than the average thickness of each of the two paper-based sheets 30, 40.

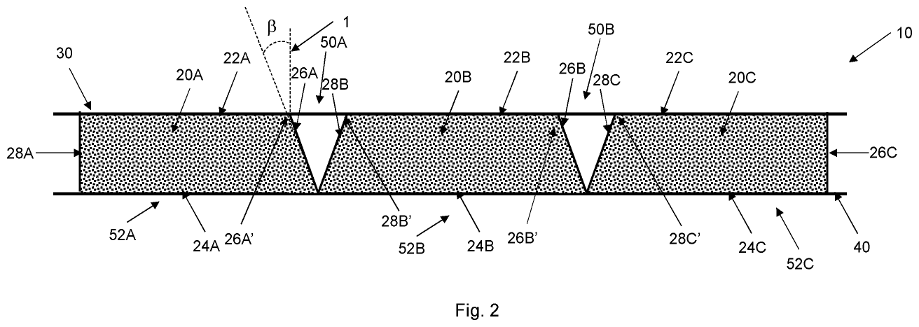

The at least one hinge section 50 is interposed between two consecutive or adjacent beveled edges 26, 28. The two beveled edges 26, 28 face each other and thereby together form an angle α when the multiple cellulose-based air-laid or solid foam substrates 20 are arranged one after another along a longitudinal axis A of the packaging insert 10. This angle α formed by the two beveled edges 26, 28 facing each other is in a cross-sectional plane of the packaging insert 10 taken along the longitudinal axis A and further as shown in FIG. 1. A beveled edge 26, 28 is an edge of a cellulose-based air-laid or solid foam substrate 20 that is not perpendicular to the main sides 22, 24 of the cellulose-based air-laid or solid foam substrate 20. The beveled edge 26, 28 is thereby cut at an angle β, see FIG. 2, that is less than 90°. In fact, the sum of the angles β, at which the two facing beveled edges are cut, form the angle α, which is less than 90°. If the two facing beveled edges 26, 28 of the consecutive cellulose-based air-laid or solid foam substrates 20 are cut in the same angle β but of opposite sign, then the angle α formed by the two facing beveled edges 26, 28 is equal to 2×β, i.e., α=2×β.

As is shown in FIG. 1, the two beveled edges 26, 28 form, when facing each other and when the consecutive cellulose-based air-laid or solid foam substrate 20 are arranged one after another along the axis A, a wedge-shaped channel or gap 51 between the first and second paper-based sheets 30, 40, and in particular between the portion 34 of the first paper-based sheet 30 and the portion 44 of the second paper-based sheet 40 within the at least one hinge section 50. In FIG. 1, this wedge-shaped channel 51 has its base at the portion 34 of the first paper-based sheet 30 within the hinge section 50, its tip at the portion 44 of the second paper-based sheet 40 within the hinge section 50 and its sides along the beveled edges 26, 28 of the consecutive cellulose-based air-laid or solid foam substrates 20. In such a case, this tip of the wedge-shaped channel 51 runs along the second paper-based sheet 40 and have the angle α.

Hence, in an embodiment, the at least one hinge section 50 comprises a wedge-shaped channel 51 defined by the beveled edges 26, 28 of the consecutive cellulose-based air-laid or solid foam substrates 20 and the first and second paper-based sheets 30, 40. In particular, the at least one hinge section 50 comprises a channel or gap 51 that is wedge-shaped when the multiple cellulose-based air-laid or solid foam substrates 20 are arranged one after another along a longitudinal axis A of the packaging insert 10.

As is shown in FIG. 1, the portions 25, 27 of the beveled edges 26, 28 adjacent the second paper-based sheet 40, i.e., the portions 25, 27 of the beveled edges 26, 28 forming the tip of the wedge-shaped channel 51, are preferably arranged close to each other and may even meet at the tip of the wedge-shaped channel 51.

As is shown in FIG. 2 and further mentioned above, the beveled edges 26A, 28B, 26B, 28C of the consecutive cellulose-based air-laid or solid foam substrates 20A, 20B, 20C, see FIG. 2, are cut at an angle β that is less than 45° relative to a normal 1 of the first and second main sides 22A, 22B, 22C, 24A, 24B, 24C of the multiple cellulose-based air-laid or solid foam substrates 20A, 20B, 20C.

In an embodiment, each beveled edge 26A, 28B, 26B, 28C of the consecutive cellulose-based air-laid or solid foam substrates 20A, 20B, 20C is cut at a same angle β that is less than 45° relative to the normal 1. The embodiments are, however, not limited to cutting the beveled edges 26A, 28B, 26B, 28C at a same angle. In an embodiment, the facing beveled edges 26A, 28B, 26B, 28C may be cut at different angles β relative to the normal 1. For instance, the beveled edge 26A of the first cellulose-based air-laid or solid foam substrate 20A in FIG. 2 may be cut at an angle B1 relative to the normal 1, whereas the beveled edge 28B of the second cellulose-based air-laid or solid foam substrate 20B may be cut at an angle β₂ relative to the normal 1. These two angles β₁, β₂ are then both less than 45° but may be different. In such an embodiment, the angle a formed by these two beveled edges 26A, 28B is β₁+β₂. Thus, facing beveled edges 26A, 28B, 26B, 28C may be cut at angles β₁ and β₂, respectively, which together form the angle α. These angles β₁ and β₂ may the same or different for a pair of facing beveled edges 26A, 28B, 26B, 28C. Furthermore, the angles β₁ and β₂ may be the same or different for different pairs of beveled edges 26A, 28B, 26B, 28C if the packaging insert 10 comprises multiple hinge sections 50A, 50B.

In an embodiment, the beveled edges 26, 28 of the consecutive cellulose-based air-laid or solid foam substrates 20 form an angle α that is selected within an interval of from 45° up to but not including 90°. In a preferred embodiment, this angle a is selected within an interval of from 45° up to 85°, and more preferably selected within an interval of from 45° up to 80°.

In an embodiment, the at least one hinge section 50 comprises a portion 34 of the first paper-based sheet 30 that is not attached to any cellulose-based air-laid or solid foam substrate 20 or to the second paper-based sheet 40 and a portion 44 of the second paper-based sheet 40 that is not attached to any cellulose-based air-laid or solid foam substrate 20 or to the first paper-based sheet 30. These respective portions 34, 44 of the first and second paper-based sheets 30, 40 in the hinge section 50 correspond to a portion 34, 44 of the first or second paper-based sheet 30, 40 that is between consecutive sandwich sections 52. Hence, the first paper-based sheet 30 comprises sheet portions or sections 31 within the sandwich sections 52, with each such sheet portion or section 31 attached to a respective first main side 22 of a cellulose-based air-laid or solid foam substrate 20, and a respective intermediate sheet portion or section 34 within the at least one hinge section 50, with each such intermediate sheet portion or section 34 not attached to any cellulose-based air-laid or solid foam substrate 20 or to the second paper-based sheet 40. Each intermediate sheet portion or section 34 is positioned between consecutive sheet portions or sections 31 of consecutive sandwich sections 52. Correspondingly, the second paper-based sheet 40 comprises sheet portions or sections 41 within the sandwich sections 52, with each such sheet portion or section 41 attached to a respective second main side 24 of a cellulose-based air-laid or solid foam substrate 20, and a respective intermediate sheet portion or section 44 within the at least one hinge section 50. However, each such intermediate sheet portion or section 44 of the second paper-based sheet 40 is not attached to any cellulose-based air-laid or solid foam substrate 20 or to the first paper-based sheet 30. Each intermediate sheet portion or section 44 is positioned between consecutive sheet portions or sections 41 of consecutive sandwich sections 52.

In an embodiment, the packaging insert 10 comprises two sandwich sections 52 with an intermediate hinge section 50 as shown in FIG. 1. Such a packaging insert 10 can then be folded at the hinge section 50 to form an L-shaped packaging insert 10 when inserted into a packaging 80.

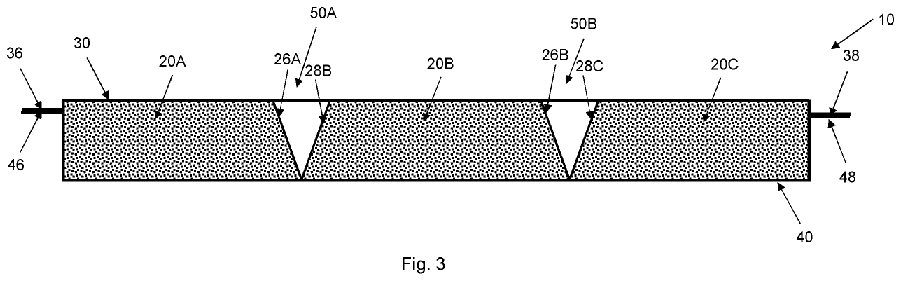

In other embodiments, the packaging insert 10 comprises more than two sandwich sections 52A, 52B, 52C and thereby more than one hinge section 50A, 50B, see FIGS. 2 and 3. In an embodiment as shown in these FIGS. 2 and 3, the packaging insert 10 comprises at least a first cellulose-based air-laid or solid foam substrate 20A, a second cellulose-based air-laid or solid foam substrate 20B and a third cellulose-based air-laid or solid foam substrate 20C. In such an embodiment, edges 26A, 28B of the first and second cellulose-based air-laid or solid foam substrates 20A, 20B facing each other are beveled edges 26A, 26B and form an angle a between each other that is less than 90°. Correspondingly, edges 26B, 28C of the second and third cellulose-based air-laid or solid foam substrates 20B, 20C facing each other are beveled edges 26B, 26A and form an angle a between each other that is less than 90°.

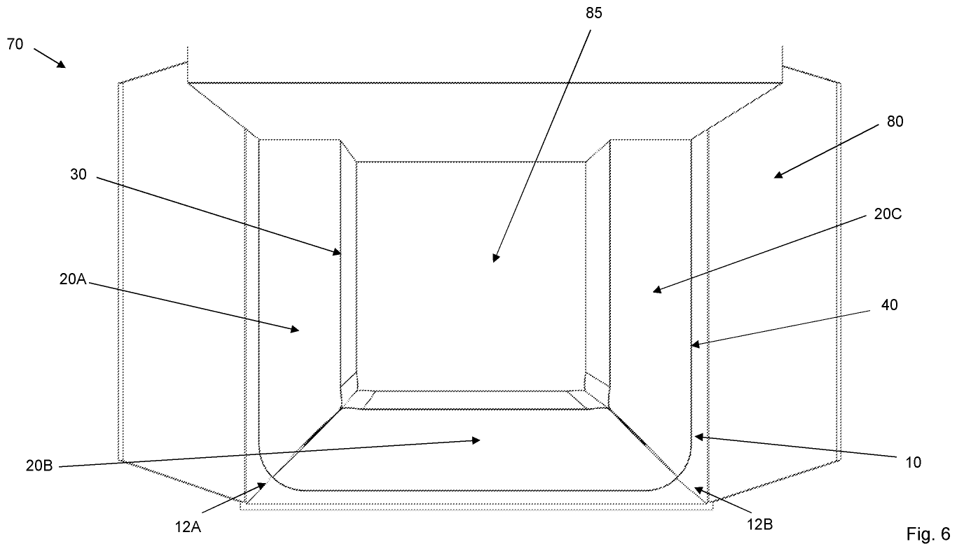

In this embodiment, the packaging insert 10 thereby comprises three sandwich sections 52A, 52B, 52C and two hinge sections 50A, 50B with a first hinge section 50A interposed between the first and second sandwich sections 52A, 52B and a second hinge section 50B interposed between the second and third sandwich sections 52B, 52C. Such a packaging insert 10 can be folded twice since it has two hinge sections 50A, 50B. The so-folded packaging insert 10 then forms a U-shaped packaging insert 10 when inserted into a packaging 80 as shown in FIGS. 5 and 6.

The embodiments are, however, not limited to packaging inserts 10 consisting of two or three sandwich sections 52, 52A, 52B, 52C and one or two hinge sections 50, 50A, 50B as shown in FIGS. 1 to 3. A packaging insert 10 may, thus, comprise more than three sandwich sections 52, 52A, 52B, 52C with a respective hinge section 50, 50A, 50B interposed between consecutive sandwich sections 52, 52A, 52B, 52C.

The angle α formed by the beveled edges 26A, 28B of the first and second cellulose-based air-laid or solid foam substrates 20A, 20B may be the same as the angle a formed by the beveled edges 26B, 28C of the second and third cellulose-based air-laid or solid foam substrates 20B, 20C. The embodiments are, however, not limited thereto. For instance, the beveled edges 26A, 28B of the first and second cellulose-based air-laid or solid foam substrates 20A, 20B may form an angle α₁ and the beveled edges 26B, 28C of the second and third cellulose-based air-laid or solid foam substrates 20B, 20C form an angle α₂. In such an example, both angles α₁, α₂ are less than 90° but do not need to be the same, i.e., α₁≠α₂.

In an embodiment, the first cellulose-based air-laid or solid foam substrate 20A comprises a straight edge 28A and a beveled edge 26A, the second cellulose-based air-laid or solid foam substrate 20B comprises two beveled edges 26B, 28B and the third cellulose-based air-laid or solid foam substrate 20C comprises a straight edge 26C and a beveled edge 28C, see FIG. 2. Hence, in a preferred embodiment, only the edges of the multiple cellulose-based air-laid or solid foam substrates 20A, 20B, 20C facing another cellulose-based air-laid or solid foam substrate 20A, 20B, 20C when arranged one after another along the longitudinal axis A are beveled edges 26A, 26B, 28B, 28C. However, the first or front edge 28A of the first or front cellulose-based air-laid or solid foam substrate 20A and thereby of the packaging insert 10 and the last edge 26C of the third or last cellulose-based air-laid or solid foam substrate 20C and thereby of the packaging insert 10 are straight edges 28A, 26C, i.e., cut at an angle that is equal to 90°. A straight edge 28A, 26C is perpendicular to the main sides 22, 24 of the multiple cellulose-based air-laid or solid foam substrates 20A, 20B, 20C.

The multiple cellulose-based air-laid or solid foam substrates 20, 20A, 20B, 20C preferably have the same dimensions, i.e., average thickness, average length and average width. The embodiment are, however, not limited thereto. Preferably, the multiple cellulose-based air-laid or solid foam substrates 20, 20A, 20B, 20C have the same or substantially the same thickness and width but may not necessarily have the same length. For instance, if the packaging insert 10 is to be positioned within a cavity 85 of a rectangular packaging 80 having side walls 86 that are longer than the front wall 88 (and back wall) then the lengths of the first and third cellulose-based air-laid or solid foam substrates 20A, 20C are preferably substantially the same but longer than the length of the second cellulose-based air-laid or solid foam substrate 20B in order to obtain a U-shaped packaging insert 10 that runs along the side and front walls 86, 88 as indicated in FIG. 5. It is also possible that the cellulose-based air-laid or solid foam substrates 20, 20A, 20C, 20C of the packaging insert 10 have different thicknesses (but the same length and width), different widths (but the same thickness and width), different lengths (but the same thickness and width), or indeed different thicknesses and widths (but the same length), different thicknesses and lengths (but the same width), different widths and lengths (but the same thickness), or different thicknesses, lengths and widths.

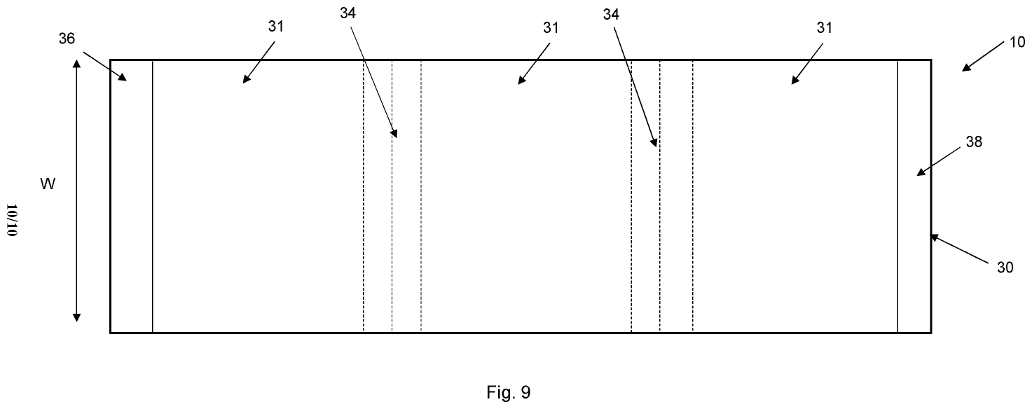

The first and second paper-based sheets 30, 40 preferably have a length that is equal to or longer the combined lengths of the multiple sandwich sections 52, 52A, 52B, 52C (and thereby of the multiple cellulose-based air-laid or solid foam substrates 20, 20A, 20B, 20C) and of the at least one hinge section 50, 50A, 50B. The width of the first and second paper-based sheets 30, 40 is preferably substantially equal to the width of the multiple cellulose-based air-laid or solid foam substrates 20, 20A, 20B, 20C, or in case the multiple cellulose-based air-laid or solid foam substrates 20, 20A, 20B, 20C have different widths, preferably a width selected within an interval equal to the smallest width and the largest width of the multiple cellulose-based air-laid or solid foam substrates 20, 20A, 20B, 20C. In a preferred embodiment, the first paper-based sheet 30 has dimensions and a general shape to cover the first main sides 22 of the multiple cellulose-based air-laid or solid foam substrates 20, 20A, 20B, 20C and the second paper-based sheet 40 correspondingly has dimensions and a general shape to cover the second main sides 24 of the multiple cellulose-based air-laid or solid foam substrates 20, 20A, 20B, 20C as shown in FIG. 9.

In an embodiment, see FIG. 3, an end portion 38 of the first paper-based sheet 30 extends beyond a last cellulose-based air-laid or solid foam substrate 20C, i.e., the third cellulose-based air-laid or solid foam substrate 20C in FIG. 3, of the multiple cellulose-based air-laid or solid foam substrates 20A, 20B, 20C. Correspondingly, an end portion 48 of the second paper-based sheet 40 extends beyond the last cellulose-based air-laid or solid foam substrate 20C of the multiple cellulose-based air-laid or solid foam substrates 20A, 20B, 20C. In such a case, the end portions 38, 48 of the first and second paper-based sheets 30, 40 are preferably attached to each other.

In another embodiment, a front portion 36 of the first paper-based sheet 30 extends beyond a front cellulose-based air-laid or solid foam substrate 20A, i.e., the first cellulose-based air-laid or solid foam substrate 20A in FIG. 3, of the multiple cellulose-based air-laid or solid foam substrates 20A, 20B, 20C. Correspondingly, a front portion 46 of the second paper-based sheet 40 extends beyond the front cellulose-based air-laid or solid foam substrate 20A of the multiple cellulose-based air-laid or solid foam substrates 20A, 20B, 20C. In such a case, the front portions 36, 46 of the first and second paper-based sheets 30, 40 are preferably attached to each other.

It is also possible to combine these two embodiments as shown in FIG. 3 with both the front portions 36, 46 of the first and second paper-based sheets 30, 40 attached to each other and the end portions 38, 48 of the first and second paper-based sheets 30, 40 attached to each other.

The front portions 36, 46 may be attached to each other and/or the end portions 38, 48 may be attached to each other using an adhesive. The adhesive is preferably the same adhesive that is used to attach the first and second paper-based sheets 30, 40 to the multiple cellulose-based air-laid or solid foam substrates 20, 20A, 20B, 20C, which is further described herein.

The attachment of the front and/or end portions 36, 46, 38, 48 of the first and second paper-based sheet 30, 40 to each other means that the end sides of the front and/or last cellulose-based air-laid or solid foam substrate 20A, 20C will be protected by the paper-based sheets 30, 40. This reduces the risk of cellulose-based particles or fibers from falling off the packaging insert 10 when inserting the packaging insert 10 into a packaging 80. In such a process, the end sides of the front and/or last cellulose-based air-laid or solid foam substrate 20A, 20C may engage another packaging insert 10 already inserted in the cavity 85 of the packaging 80 or a wall 86, 88 of the packaging 80. Such a contact between unprotected end sides of the front and/or last cellulose-based air-laid or solid foam substrate 20A, 20C and the other packaging insert 10 of the wall 86, 88 may cause cellulose-based particles or fibers from falling off the end sides and fall into the cavity 85 of the packaging 80. Furthermore, the paper-based sheets 30, 40 generally have a smoother surface as compared to the cellulose-based air-laid or solid foam substrates 20A, 20B, 20C, which slides easier along the walls 86, 88 of the packaging and along the paper-based sheets 30, 40 of another packaging insert 10. As a consequence, the embodiment as shown in FIG. 3 with attached front portions 36, 46 and/or attached end portions 38, 48 are generally easier to handle when inserting the packaging insert 10 into a cavity 85 of packaging 80 as compared to the embodiment of the packaging insert 10 shown in FIG. 2 having free front and end portions of the first and second paper-based sheets 30, 40.

The front portions 36, 46 and the end portions 48, 48 could be attached to each other anywhere along the end sides of the front and last cellulose-based air-laid or solid foam substrates 20A, 20C. FIG. 3 illustrates an embodiment, where the front portions 36, 46 and the end portions 48, 48 are attached to each other closer to one of the main sides of the front and last cellulose-based air-laid or solid foam substrates 20A, 20C rather than in the middle of the end sides of the front and last cellulose-based air-laid or solid foam substrates 20A, 20C. In such an embodiment, the attached front portions 36, 46 and the end portions 48, 48 could be folded as shown in FIG. 6 into the interior partly encircled by the U-shaped packaging insert 10 when folded in the packaging 80. The attached front portions 36, 46 and the end portions 38, 48 form respective sealing lips that seal the packaging insert 10 against a side wall 86, 88 or bottom 82 of a packaging 80 or against another packaging insert 10 inserted into the packaging 80.

Furthermore, the attached front portions 36, 46 and the end portions 38, 48 constitute protruding structures that could easily be gripped by a user when retrieving a folded packaging insert 10 from the cavity 85 of a packaging 80. Hence, these attached front and end portions 36, 38, 46, 48 could be used as hold when handling the packaging insert 10.

In an embodiment, the first paper-based sheet 30 comprises an adhesive 60, see FIG. 1, provided or applied, such as coated or sprayed, onto at least a portion of a main side 32 of the first paper-based sheet 30 and attached to the first main sides 22 of the multiple cellulose-based air-laid or solid foam substrates 20 with the main side 32 of the first paper-based sheet 30 facing the first main sides 22 of the multiple cellulose-based air-laid or solid foam substrates 20. Correspondingly, the second paper-based sheet 40 preferably comprises an adhesive 60 provided onto at least a portion of a main side 42 of the second paper-based sheet 40 and attached to the second main sides 24 of the multiple cellulose-based air-laid or solid foam substrates 20 with the main side 42 of the second paper-based sheet 40 facing the second main sides 24 of the multiple cellulose-based air-laid or solid foam substrates 20.

The same adhesive 60 may be coated on both the first and second paper-based sheets 30, 40 or different adhesives 60 may be coated on both the first and second paper-based sheets 30, 40.

The adhesive 60 may then be provided or applied, such as coated or sprayed, onto the whole portions 31, 41, 44 of the main sides 32, 42 of the first and second paper-based sheets 30, 40. Alternatively, the adhesive 60 could be provided onto merely a part of the main sides 32, 42 in the sandwich sections 52 and in the at least one hinge section 50 for the main side 42 of the second paper-based sheet 40. For instance, the adhesive 60 could be applied along a frame in connection with the circumference of the portions 31, 41, 44 of the main sides 32, 42 of the first and second paper-based sheets 30, 40. It is also possible to apply the adhesive 60 at multiple separate positions on the main sides 32, 42 of the first and second paper-based sheets 30, 40.

As an alternative, or complement, to provide at least a portion 31, 41, 44 of the main sides 32, 42 of the first and second paper-based sheets 30, 40 with the adhesive 60, the adhesive 60 may be applied onto at least a portion of the first main sides 22 and/or at least a portion of the second main sides 42 of the multiple cellulose-based air-laid or solid foam substrates 20.

In an embodiment, the adhesive is selected from the group consisting of a pressure-sensitive adhesive, a solvent-based adhesive, a polymer dispersion adhesive, a contact adhesive and a hot melt adhesive. Pressure-sensitive adhesives form a bond by the application of light pressure to marry the adhesive with the adherend. Solvent-based adhesives are a mixture of polymer ingredients dissolved in a solvent. As the solvent evaporates, the adhesive hardens. Correspondingly, polymer dispersion adhesives, also referred to as emulsion adhesives, are milky-white dispersions often based on polyvinyl acetate (PVAc). Contact adhesives need to be applied onto both the paper-based sheets 30, 40 and the multiple cellulose-based air-laid or solid foam substrates 20 and allowed some time to dry before the paper-based sheets 30, 40 are attached to the cellulose-based air-laid or solid foam substrates 20. Hot melt adhesives are thermoplastic polymers applied in molten form that solidify upon cooling to form strong bonds.

Currently preferred adhesives include pressure-sensitive adhesives, solvent-based adhesives, polymer dispersion adhesives, and hot melt adhesives since they can provide strong bonds between the first and second paper-based sheets 30, 40 and the multiple cellulose-based air-laid or solid foam substrates 20 but only need to be applied onto the main sides 32, 42 of the paper-based sheets 30, 40 or the main sides 22, 24 of the multiple cellulose-based air-laid or solid foam substrates 20.

An illustrative, but non-limiting, example of adhesives that could be used to attach the paper-based sheets 30, 40 onto the cellulose-based air-laid or solid foam substrates 20 includes low density polyethylene (LDPE) as an example of hot melt adhesive. Other non-limiting examples include wood glues or adhesives, such as polyvinyl-acetate-based wood glues or adhesives, and wallpaper glues or adhesives, such as starch-based wallpaper glues or adhesives.

The first and second paper-based sheets 30, 40 could be any paper-based sheets 30, 40 that could be attached to the multiple cellulose-based air-laid or solid foam substrates 20 and is flexible enough to be folded at the at least one hinge section 50. In an embodiment, the first and second paper-based sheets 30, 40 are selected from the group consisting of paper sheets, paperboard sheets, paper tissue sheets and non-woven paper sheets.

As an example, the first and second paper-based sheets 30, 40 could be selected from the group consisting of Kraft paper sheets, cardboard sheets, cartonboard sheets and corrugated board sheets. Generally, Kraft paper sheets are thinner and more flexible as compared to cardboard sheets, cartonboard sheets and corrugated board sheets. Illustrative examples of Kraft paper sheet that could be used in the packaging insert include Kraft paper sheets with a grammage from 15 up to 135 g/m², preferably with a grammage from 20 up to 60 g/m², and more preferably with a grammage from 30 up to 50 g/m².

The first and second paper-based sheets 30, 40 are typically made of a same type of paper-based material, such as same type of Kraft paper sheet. It is, however, possible to use different types of paper-based materials for the first and second paper-based sheets 30, 40, such as different types of Kraft paper sheets.

The outer main side(s) of the first and/or second paper-based sheets 30, 40 facing away from the cellulose-based air-laid or solid foam substrates 20 may optionally be coated, such as to provide a water repelling coating or barrier, a grease repelling coating or barrier, a colored coating and/or a structured coating. The first and/or the second paper-based sheets 30, 40 may comprise one or more layers of paper-based materials. Thus, the first and/or the second paper-based sheets 30, 40 can be a paper-based multi-layer or laminate sheet.

The first and second paper-based sheets 30, 40 not only keep the multiple cellulose-based air-laid or solid foam substrates 20 together and form the at least one hinge section 50. The first and second paper-based sheets 30, 40 additionally constitutes a surface cover of the first and second main sides 22, 24 of the multiple cellulose-based air-laid or solid foam substrates 20 and optionally also of the end sides as shown in FIG. 3. This surface cover relaxes the need for any surface treatment of the multiple cellulose-based air-laid or solid foam substrates 20 to reduce the dusting of cellulose-based particles or fibers from the multiple cellulose-based air-laid or solid foam substrates 20. Furthermore, the first and second paper-based sheets 30, 40 may protect the multiple cellulose-based air-laid or solid foam substrates 20 and any goods protected by the packaging insert 10 from moisture, grease or other liquids that may otherwise penetrate through the cellulose-based air-laid or solid foam substrates 20.

An air-laid or solid foam substrate 20 is cellulose-based if the air-laid or solid foam substrate 20 comprises cellulose and/or lignocellulose material as a main part or constituent. Various such cellulose and/or lignocellulose materials could be comprised in the cellulose-based air-laid or solid foam substrate 20 including, but not limited to, cellulose and/or lignocellulose fibers, cellulose and/or lignocellulose particles, and/or cellulose and/or lignocellulose fibrils.

In an embodiment, the multiple cellulose-based air-laid or solid foam substrates 20 comprise cellulose and/or lignocellulose fibers. Lignocellulose as used herein is a mixture of cellulose and lignin. The cellulose and/or lignocellulose fibers may additionally contain hemicellulose. In a particular embodiment, the cellulose and/or lignocellulose fibers are cellulose and/or lignocellulose pulp fibers produced by chemical, mechanical and/or chemi-mechanical pulping of softwood and/or hardwood. For instance, the cellulose and/or lignocellulose pulp fibers are in a form selected from the group consisting of sulfate pulp, sulfite pulp, thermomechanical pulp (TMP), high temperature thermomechanical pulp (HTMP), mechanical fiber intended for medium density fiberboard (MDF-fiber), chemi-thermomechanical pulp (CTMP), high temperature chemi-thermomechanical pulp (HTCTMP), and a combination thereof.

The cellulose and/or lignocellulose pulp fibers may be bleached or unbleached.

The cellulose and/or lignocellulose fibers can also be produced by other pulping methods and/or from other cellulosic or lignocellulosic raw materials than wood, such as flax, jute, hemp, kenaf, bagasse, cotton, bamboo, straw, or rice husk. It is also possible to use natural fibers that are a mixture of fibers from different raw materials, such as a mixture of wood and any of the materials mentioned above.

The multiple cellulose-based air-laid or solid foam substrates 20 may comprise one or more additives in addition to the cellulose and/or lignocellulose material. Illustrative, but non-limiting, examples of such additives include foam forming agents, also denoted as foaming agents in the art, thickener, electrically conducting or semiconducting fillers, coupling agents, flame retardants, dyes, impact modifiers, etc.

In an embodiment, the average density of the multiple cellulose-based air-laid or solid foam substrate 20 is preferably selected within an interval of from 10 to 60 kg/m³. In a particular embodiment, the average density of the multiple cellulose-based air-laid or solid foam substrate 20 is within an interval of from 15 to 60 kg/m³, and more preferably within an interval of from 15 to 50 kg/m³.

In an embodiment, the multiple cellulose-based air-laid or solid foam substrates 20 are multiple cellulose-based air-laid substrates 20. An air-laid substrate, also referred to as air-laid panel, is formed from an air-laid material by a process known as air-laying, in which cellulose and/or lignocellulose fibers and polymer binders are mixed with air to form a porous fiber mixture deposited onto a support and consolidated or bonded by heating. This air-laid substrate is characterized by being porous, having the character of an open cell foam and being produced in a so-called dry forming method, i.e., generally without addition of water. The air-laying process was initially described in U.S. Pat. No. 3,575,749. Hence, an air-laid substrate may be formed from an air-laid blank, dry-laid blank, an air-laid mat, dry-laid blank, air-laid web or dry-laid web.

In an embodiment, each cellulose-based air-laid substrate 20 comprises the cellulose and/or lignocellulose fibers at a concentration of at least 70% by weight of the cellulose-based air-laid substrate 20 and a polymer binder at a concentration selected within an interval of from 2.5 up to 30% by weight of the cellulose-based air-laid substrate 20.

In a preferred embodiment, each cellulose-based air-laid substrate 20 comprises cellulose and/or lignocellulose fibers in a concentration of at least 72.5%, more preferably at least 75%, such as at least 77.5%, at least 80%, at least 82.5%, at least 85% by weight of the cellulose-based air-laid substrate 20. In some applications, even higher concentrations of the cellulose and/or lignocellulose fibers may be used, such as at least 87.5%, or at least 90%, at least 92.5%, at least 95% or at least 97.5% by weight of the cellulose-based air-laid substrate 20.

In some embodiments, each cellulose-based air-laid substrate 20 comprises the polymer binder at a concentration selected within an interval of from 5 up to 30% by weight of the cellulose-based air-laid substrate 20, preferably within an interval of from 10 up to 25% by weight, such as from 12.5 up to 22.5% by weight of the cellulose-based air-laid substrate 20, or within an interval of from 15 up to 20% by weight of the cellulose-based air-laid substrate 20.

The multiple cellulose-based air-laid substrates 20 may also comprise a minor portion of synthetic material or fibers that are mixed with the cellulose and/or lignocellulose fibers. Such synthetic material or fibers that may be mixed with the cellulose and/or lignocellulose fibers include, for instance, glass or mineral wool, and/or carbon fibers. Any such synthetic material or fibers may be added at an amount of no more than 10% (w/w) of the cellulose-based air-laid substrate 20, preferably no more than 8% (w/w), such as no more than 6% (w/w), or preferably no more than 4% (w/w) of the cellulose-based air-laid substrate 20.

The multiple cellulose-based air-laid substrates 20 may also comprise a minor portion of synthetic material or fibers that are mixed with the cellulose and/or lignocellulose fibers. Such synthetic material or fibers that may be mixed with the cellulose and/or lignocellulose fibers include, for instance, glass or mineral wool, and/or carbon fibers. Any such synthetic material or fibers may be added at an amount of no more than 10% (w/w) of the cellulose-based air-laid substrate 20, preferably no more than 8% (w/w), such as no more than 6% (w/w), or preferably no more than 4% (w/w) of the cellulose-based air-laid substrate 20.

Length of fibers, such as cellulose and/or lignocellulose fibers, as referred to herein is length weighted average fiber length. Length weighted average fiber length is calculated as the sum of individual fiber lengths squared divided by the sum of the individual fiber lengths as described in e.g., ISO 16065-1 or ISO 16065-2.

In an embodiment, the cellulose and/or lignocellulose fibers have a length weighted average fiber length of up to 10 mm, preferably of up to 8 mm, more preferably of up to 6 mm, and most preferably up to 5 mm. In a particular embodiment, the cellulose and/or lignocellulose fibers have a length weighted average fiber length selected within an interval of from 1 mm up to 10 mm, preferably selected within an interval of from 1 mm up to 8 mm, more preferably selected within an interval of from 1 mm up to 6 mm, and most preferably selected within an interval of from 1 mm up to 5 mm.

It is also possible to include a minor portion of longer fibers having a length weighted average fiber length of 10 mm or more.

The polymer binder is included in the multiple cellulose-based air-laid substrates 20 to bind the multiple cellulose-based air-laid substrates 20 together and preserve their form and structure during use, handling, and storage. In an embodiment, the polymer binder may also assist in building up the foam-like structure of the multiple cellulose-based air-laid substrates 20. The polymer binder is, in such an embodiment, intermingled with the cellulose and/or lignocellulose fibers during production of the multiple cellulose-based air-laid substrates 20. The polymer binder may be added in the form of a powder but is more often added in the form of polymer fibers that are intermingled with the cellulose and/or lignocellulose fibers during production. Alternatively, or in addition, the polymer binder may be added as solution, emulsion, or dispersion into and onto the cellulose and/or lignocellulose fibers during the production process.

In a particular embodiment, the polymer binder is selected from the group consisting of a polymer powder, polymer fibers and a combination thereof.

The polymer binder could be a natural or synthetic polymer binder, or a mixture of natural polymer binders, a mixture of synthetic polymer binders, or a mixture of natural and synthetic polymer binders, but is preferably a thermoplastic polymer binder.

In an embodiment, the polymer binder is made from i) a material selected from the group consisting of polyethylene (PE), ethylene acrylic acid copolymer (EAA), ethylene-vinyl acetate (EVA), polypropylene (PP), polystyrene (PS), such as styrene-butadiene rubber (SBR) or styrene acrylate copolymer, polybutylene adipate terephthalate (PBAT), polybutylene succinate (PBS), polylactic acid (PLA), polyethylene terephthalate (PET), polycaprolactone (PCL), polyvinyl acetate (PVAc), polyurethane (PU), copolymers thereof and mixtures thereof, and ii) optionally one or more additives.

In another embodiment, the polymer binder is a polymer binder that is water soluble at a repulping temperature of a repulping process. Such water soluble polymer binders imply that the packaging insert 10 can be recycled in a repulping process. In such an embodiment, the polymer binder is made from i) a material selected from the group consisting of polyvinyl alcohol (PVA), polyethylene glycol (PEG), poly(2-ethyl-2-oxazoline) (PEOX), polyvinyl ether (PVE), polyvinylpyrrolidone (PVP), polyacrylic acid (PAA), polymethacrylic acid (PMAA), copolymers thereof and mixtures thereof, and ii) optionally one or more additives.

Hence, in an embodiment, the polymer binder is made of a material selected from the above-mentioned groups. In another embodiment, the polymer binder is made of a material selected from the above-mentioned groups and one or more additives.

In an embodiment, the polymer binder is or comprises, such as consists of, mono-component and/or bi-component polymer fibers. Bi-component polymer fibers, also known as bico fibers, comprise a first polymer, copolymer and/or polymer mixture and a second, different polymer, copolymer and/or polymer mixture. Most often the bi-component polymer fiber comprises a core made of the first polymer, copolymer and/or polymer mixture and a sheath made of the second polymer, copolymer and/or polymer mixture, although other combinations of two or even more polymers, copolymers and/or polymer mixtures are possible.

In a particular embodiment, the polymer binder is or comprises, such as consists of, mono-component polymer fibers made of i) a material selected from the group consisting of PE, EAA, EVA, PP, PS, PBAT, PBS, PLA, PET, PCL, PVAc, PU, PVA, PEG, PEOX, PVE, PVP, PAA, PMAA, copolymers thereof and mixtures thereof, and ii) optionally one or more additives. In another particular embodiment, the polymer binder is or comprises, such as consists of, bi-component polymer fibers having a first material, such as a core made of i) a first material, selected from the group consisting of PE, EAA, EVA, PP, PS, PBAT, PBS, PLA, PET, PCL, PVAc, PU, PVA, PEG, PEOX, PVE, PVP, PAA, PMAA, copolymers thereof and mixtures thereof, and ii) optionally one or more additives, and a second material, such as a sheath made of i) a second material, typically a different material, selected from the group consisting of PE, EAA, EVA, PP, PS, PBAT, PBS, PLA, PET, PCL, PVAc, PU, PVA, PEG, PEOX, PVE, PVP, PAA, PMAA, copolymers thereof and mixtures thereof, and ii) optionally one or more additives. In a further embodiment, the polymer binder is or comprises, such as consists of, a combination or mixture of mono-component polymer fibers made of i) a material selected from the group consisting of PE, EAA, EVA, PP, PS, PBAT, PBS, PLA, PET, PCL, PVAc, PU, PVA, PEG, PEOX, PVE, PVP, PAA, PMAA, copolymers thereof and mixtures thereof, and ii) optionally one or more additives, and bi-component polymer fibers having i) materials, such as of the core and/or sheath, selected from the group consisting of PE, EAA, EVA, PP, PS, PBAT, PBS, PLA, PET, PCL, PVAc, PU, PVA, PEG, PEOX, PVE, PVP, PAA, PMAA, copolymers thereof and mixtures thereof, and ii) optionally one or more additives.

The polymer binder could be made of a single type of polymer fibers, i.e., made of a same material in the case of mono-component polymer fibers or made of the same materials in the case of bi-component polymer fibers. However, it is also possible to use a polymer binder made of one or multiple, i.e., two or more, different mono-component polymer fibers made of different materials and/or one or multiple different bi-component polymer fibers made of different materials.

In an embodiment, the polymer binder is a polymer powder made of i) a material selected from the group consisting of PE, EAA, EVA, PP, PS, PBAT, PBS, PLA, PET, PCL, PVAc, PU, PVA, PEG, PEOX, PVE, PVP, PAA, PMAA, copolymers thereof and mixtures thereof, and ii) optionally one or more additives.

The multiple cellulose-based air-laid substrates 20 may comprise one or more additives in addition to the natural fibers and the polymer binder as mentioned in the foregoing. One or more additives could be added to the polymer binder and/or added when producing the polymer binder. Alternatively, or in addition, one or more additives could be added to the cellulose and/or lignocellulose fibers. Alternatively, or in addition, one or more additives could be added to the cellulose and/or lignocellulose fibers and the polymer binder.

In a particular embodiment, the polymer binder is a natural polymer selected from the group consisting of starch, agar, guar gum, locust bean gum, carrageenan, and cellulose, such as fibrillar, microfibrillar or nanofibrillar cellulose.

In an embodiment, the polymer binder may be in the form of a water-based (aqueous) solution, emulsion, suspension, or dispersion of the polymer binder.

In another embodiment, the multiple cellulose-based air-laid or solid foam substrates 20 are multiple cellulose-based solid foam substrates 20. Such a cellulose-based solid form substrate 20 may be formed of cellulose and/or lignocellulose particles, cellulose and/or lignocellulose fibrils and/or cellulose and/or lignocellulose fibers. A cellulose-based solid foam substrate 20 comprising cellulose and/or lignocellulose fibers is also denoted cellulose-based fiber foam substrate 20 herein.

Examples of cellulose and/or lignocellulose fibers that could be used for the cellulose solid foam substrates 20 are as described in the foregoing.

Cellulose and/or lignocellulose fibrils may be made by fibrillating cellulose and/or lignocellulose fibers longitudinally. Such cellulose and/or lignocellulose fibrils may be in the form of so-called microfibrillated cellulose (MFC). MFC mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is or are usually required in order to make MFC manufacturing both energy efficient and sustainable. The cellulose fibers of the pulp used when producing MFC may, thus, be native or pre-treated enzymatically or chemically, for example to reduce the quantity of hemicellulose and/or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood and softwood fibers. It can also be made from microbial sources, agricultural fibers such as wheat straw pulp, bamboo, bagasse, or other non-wood fiber sources. It can be made from pulp, including pulp from virgin fiber, e.g., mechanical, chemical and/or thermomechanical pulps. It can also be made from broke or recycled paper.

Cellulose and/or lignocellulose particles may be produced by grinding cellulose and/or lignocellulose fibers and/or fibrils into particles. Such cellulose and/or lignocellulose particles generally have dimensions in the micro-or nanometer range.

The term “foam”, as used herein, refers to a substance made by trapping air or gas bubbles inside a solid or liquid. Typically, the volume of gas is much larger than that of the liquid or solid, with thin films separating gas pockets. Mechanical work is used during the formation of the foam to increase the surface area. This can occur by agitation, dispersing a large volume of gas into a liquid, or injecting a gas into a liquid. A foam forming agent, typically an amphiphilic substance, a surfactant or a surface-active component, is present to decrease surface tension. Foams can generally be liquid foam or solid foam. The cellulose-based solid foam substrates 20 of the packaging insert 10 are solid foams.

The term “solid”, as used herein regarding foam, refers to a foam that is not liquid or fluid, but firm and stable in shape. A solid is a sample of matter that retains its shape and density when not confined. The solid may be rigid, or susceptible to plastic and/or elastic deformation. The adjective solid describes the state, or condition, of matter having this property. A cellulose-based solid foam substrate is porous.

With reference to FIGS. 5 and 6, the present invention also relates to a packaging assembly 70 comprising a packaging 80 comprising a bottom 82 and multiple side walls 86, 88 defining a cavity 85. The packaging assembly 70 also comprises a packaging insert 10 according to the invention and as described herein positioned within the cavity 85.

The packaging 80 may be made of various materials. In an embodiment, the packaging 80 comprises, or consists, of a paper-based material, i.e., it is made of a paper-based material. An illustrative, but non-limiting, example of such a paper-based material is corrugated board. The paper-based material may optionally be coated with a barrier coating to, for instance, restrict ingress of moisture or grease.

The packaging insert 10 of the embodiments can be used to protect various goods in different types of packaging, including, but not limited, to boxes and containers. The bottom 82 in the packaging 80 is preferably a quadratic or rectangular bottom 82. In such a case, the packaging 80 comprises four side walls 86, 88 connected to the bottom 82. The packaging 80 may also comprise a lid 84. The embodiments are, however, not limited thereto. The packaging 80 may comprise less than four side walls 86, 88, such as three side walls 86, 88 with a triangular bottom 82, or more than four side walls 86, 88, such as five, six, seven, eight or even more side walls 86, 88 with a pentagonal, hexagonal, heptagonal or octagonal bottom 82.

In an embodiment, the packaging insert 10 is folded at the at least one hinge section 50A, 50B to form at least one corner 12A, 12B. The at least one corner 12A, 12B is preferably a 90° corner.

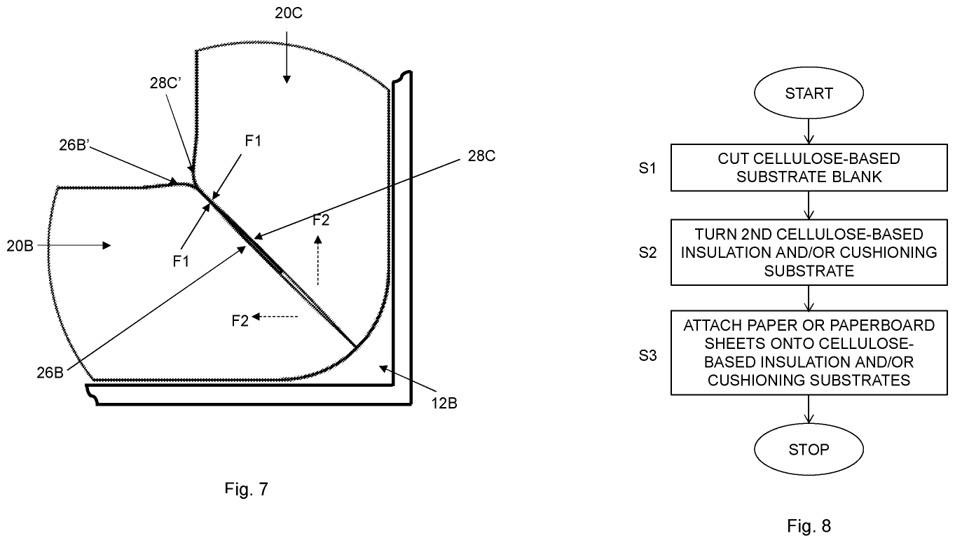

In such a case, the packaging insert 10 is preferably folded at the at least one hinge section 50A, 50B so that top portions 26A′, 26B′, 28B′, 28C′, see FIG. 2, of the beveled edges 26A, 26B, 28B, 28C of the consecutive cellulose-based air-laid or solid foam substrates 20A, 20B, 20C are next to or adjacent each other and preferably in contact with each other, see FIG. 7. These top portions 26A′, 26B′, 28B′, 28C′ of the beveled edges 26A, 26B, 28B, 28C are next to or adjacent the first paper-based sheet 30. Hence, by cutting the beveled edges 26A, 26B, 28B, 28C at an angle β<45° so that the beveled edges 26A, 26B, 28B, 28C facing each other form an angle α<90° then the second paper-based sheet 40 facing the walls 86, 88 and/or bottom 82 of the packaging 80 will be a tad too short, whereas the first paper-based sheet 30 facing in the cavity 85 of the packaging 80 will be tacked into the gap between the consecutive beveled edges 26A, 26B, 28B, 28C in the corner 12A, 12B. This in turn implies that forces F1 act on the top portions 26A′, 26B′, 28B′, 28C′ of the beveled edges 26A, 26B, 28B, 28C as in indicated in FIG. 7 to push the top portions 26A′, 26B′, 28B′, 28C′ towards each other, while forces F2 running along the length of the consecutive cellulose-based air-laid or solid foam substrates 20A, 20B, 20C act on the oppositive bottom portions of the beveled edges 26A, 26B, 28B, 28C. This in turn ensures that the consecutive cellulose-based air-laid or solid foam substrates 20A, 20B, 20C are next to or adjacent each other and minimize any gap between the cellulose-based air-laid or solid foam substrates 20A, 20B, 20C. As a consequence, the folded packaging insert 10 provides good insulation and protection even at the folds of the packaging insert 10 by reducing any gap between the cellulose-based air-laid or solid foam substrates 20A, 20B, 20C.

In the embodiments shown in FIGS. 5 and 6, the packaging insert 10 is folded at the first and second hinge sections 50A, 50B to form a U-shaped packaging insert 10. Correspondingly, a packaging insert 10 as shown in FIG. 1 is folded to have a general L-shape.

The packaging 80 can comprise a single packaging insert 10 in its cavity 85. However, it is generally preferred to include more than one packaging insert 10 in the cavity 85 to protect any goods from all sides, including bottom and above. For instance, two packaging inserts 10 as shown in FIGS. 2 and 3 could be positioned in the packaging 80 to provide protection and insulation at all four side walls 86, 88, the bottom 82 and the lid 84. It is also possible to include different types of packaging inserts 10 in a single packaging 80, such as one or more packaging inserts 10 as shown in FIG. 1 comprising two sandwich sections 52 and one or more packaging inserts 10 as shown in FIGS. 2 and 3 comprising three sandwich sections 52A, 52B, 52C.

The packaging inserts 10 of the invention efficiently protects goods and articles from impact and shock. The packaging inserts 10 also have good insulation properties and may therefore be used to provide thermal insulation, i.e., insulate heated goods or cold goods.

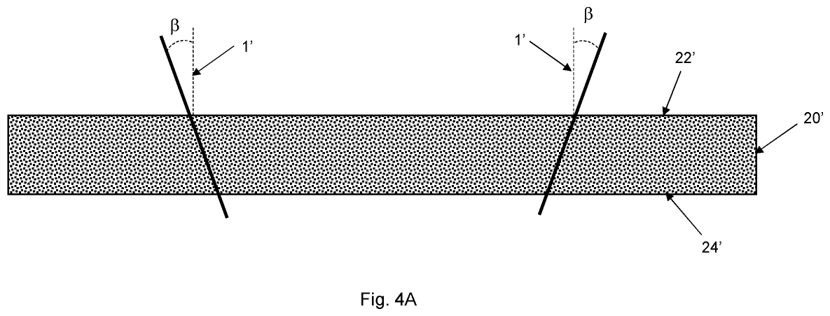

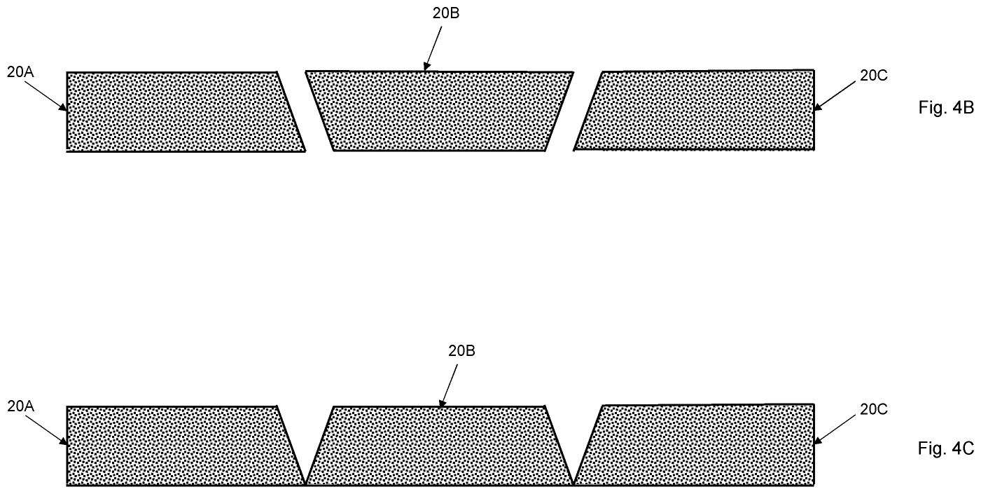

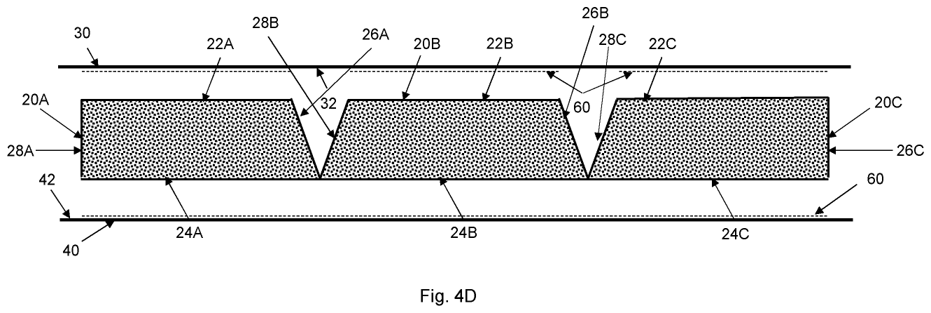

A further aspect of the invention relates to a method for producing a packaging insert 10, see FIGS. 4A-4D and 8. The method comprises cutting, in step S1, a cellulose-based air-laid or solid foam substrate blank 20′ at a first angle β less than 45° relative to a normal 1′ of a main side 22′ of the cellulose-based air-laid or solid foam substrate blank 20′ and at a second angle β equal to but of opposite sign to the first angle β to obtain at least a first cellulose-based air-laid or solid foam substrate 20A comprising a beveled edge 26A, a second cellulose-based air-laid or solid foam substrate 20B comprising two beveled edges 26B, 28B and a third cellulose-based air-laid or solid foam substrate 20C comprising a beveled edge 28C as shown in FIG. 4B. The method then comprises turning the second cellulose-based air-laid or solid foam substrate 20B upside down so that the beveled edge 26A of the first cellulose-based air-laid or solid foam substrate 20A faces a first beveled edge 28B of the second cellulose-based air-laid or solid foam substrate and the beveled edge 28C of the third cellulose-based air-laid or solid foam substrate 20C faces a second beveled edge 26B of the second cellulose-based air-laid or solid foam substrate 20B as shown in FIG. 4C. The beveled edge 26A of the first cellulose-based air-laid or solid foam substrate 20A and the first beveled edge 28B of the second cellulose-based air-laid or solid foam substrate 20B form an angle α between the beveled edges 26A, 26B that is less than 90°. Correspondingly, the beveled edge 28C of the third cellulose-based air-laid or solid foam substrate 20B and the second beveled edge 26B of the second cellulose-based air-laid or solid foam substrate 20B form an angle α between the beveled edges 26B, 28C that is less than 90°. A next step S3 comprises attaching a first paper-based 30 to first main sides 22A, 22B, 22C of the at least first, second and third cellulose-based air-laid or solid foam substrates 20A, 20B, 20C and a second paper-based sheet 40 to second main sides 24A, 24B, 24C of the at least first, second and third cellulose-based air-laid or solid foam substrate 20A, 20B, 20C to form the packaging insert 10. The packaging insert 10 comprises, see FIG. 2, a first hinge section 50A interposed between the beveled edge 26A of the first cellulose-based air-laid or solid foam substrate 20A and the first beveled edge 28B of the second cellulose-based air-laid or solid foam substrate 20B. The packaging insert 10 also comprises a second hinge section 50B interposed between the second beveled edge 26B of the second cellulose-based air-laid or solid foam substrate 20B and the beveled edge 28C of the third cellulose-based air-laid or solid foam substrate 20C.

In an embodiment, the first hinge section 50A comprises a wedge-shaped channel 51 defined by the beveled edge 26A of the first cellulose-based air-laid or solid foam substrate 20A and the first beveled edge 28B of the second cellulose-based air-laid or solid foam substrate 20B and the first and second paper-based sheets 30, 40. In this embodiment, the second hinge section 50B comprises a wedge-shaped channel 51 defined by the second beveled edge 26B of the second cellulose-based air-laid or solid foam substrate 20B and the beveled edge 28C of the third cellulose-based air-laid or solid foam substrate 20C and the first and second paper-based sheets 30, 40.

In an embodiment, the method also comprises attaching an end portion 38 of the first paper-based sheet 30 extending beyond the third cellulose-based air-laid or solid foam substrate 20C to an end portion 48 of the second paper-based sheet 40 extending beyond the third cellulose-based air-laid or solid foam substrate 20C.

In an embodiment, the method further comprises attaching a front portion 36 of the first paper-based sheet 30 extends beyond the first cellulose-based air-laid or solid foam substrate 20A to a front portion 46 of the second paper-based sheet 40 extending beyond the first cellulose-based air-laid or solid foam substrate 20A.

The embodiments described above are to be understood as a few illustrative examples of the present invention. It will be understood by those skilled in the art that various modifications, combinations, and changes may be made to the embodiments without departing from the scope of the present invention. In particular, different part solutions in the different embodiments can be combined in other configurations, where technically possible.

1. A packaging insert comprising:
a plurality of cellulose-based air-laid or solid foam substrates each having a first main side and a second main side opposite to the first main side;
a first paper-based sheet attached to the first main sides of the plurality of cellulose-based air-laid or solid foam substrates; and
a second paper-based sheet attached to the second main sides of the plurality of cellulose-based air-laid or solid foam substrates, wherein
edges of consecutive cellulose-based air-laid or solid foam substrates of the plurality of cellulose-based air-laid or solid foam substrates facing each other are beveled edges and form an angle (α) between each other that is less than 90°; and
at least one hinge section interposed between the beveled edges of the consecutive cellulose-based air-laid or solid foam substrates,
wherein the packaging insert configured to fold in the at least one hinge section.

2. The packaging insert according to claim 1, wherein the at least one hinge section comprises a wedge-shaped channel defined by the beveled edges of the consecutive cellulose-based air-laid or solid foam substrates and the first paper-based sheet and the second paper-based sheets.

3. The packaging insert according to claim 1, wherein the angle (α) less than 90° when the cellulose-based air-laid or solid foam substrates of the plurality of cellulose-based air-laid or solid foam substrates are arranged one after another along a longitudinal axis of the packaging insert.

4. The packaging insert according to claim 1, wherein the cellulose-based air-laid or solid foam substrates of the plurality of cellulose-based air-laid or solid foam substrates are sandwiched between the first paper-based sheet and the second paper-based sheets.

5. The packaging insert according to claim 1, wherein the edges of the consecutive cellulose-based air-laid or solid foam substrates are cut at an angle (β) that is less than 45° relative to a normal of the first main side and the second main sides.

6. The packaging insert according to claim 1, wherein the angle (α) is within an interval of from 45° up to but not including 90°.

7. The packaging insert according to claim 1, wherein the packaging insert comprises:
a first cellulose-based air-laid or solid foam substrate, a second cellulose-based air-laid or solid foam substrate, and a third cellulose-based air-laid or solid foam substrate,
wherein edges of the first cellulose-based air-laid or solid foam substrate and the second cellulose-based air-laid or solid foam substrates facing each other are beveled edges and form the angle (α) that is less than 90°; and
wherein edges of the second cellulose-based air-laid or solid foam substrates and the third cellulose-based air-laid or solid foam substrates facing each other are beveled edges and form an angle (α) that is less than 90°.

8. The packaging insert according to claim 7,
wherein the first cellulose-based air-laid or solid foam substrates comprises a straight edge and a beveled edge;
wherein the second cellulose-based air-laid or solid foam substrates comprises two beveled edges; and
wherein the third cellulose-based air-laid or solid foam substrates comprises a straight edge and a beveled edge.

9. The packaging insert according to claim 1,
wherein an end portion of the first paper-based sheet extends beyond a last cellulose-based air-laid or solid foam substrate of the plurality of cellulose-based air-laid or solid foam substrates;
wherein an end portion of the second paper-based sheet extends beyond the last cellulose-based air-laid or solid foam substrate; and
wherein the end portions of the first paper-based sheet and the end portion of the second paper-based sheets are attached to each other.

10. The packaging insert according to claim 1, wherein
a front portion of the first paper-based sheet extends beyond a front cellulose-based air-laid or solid foam substrate of the plurality of the cellulose-based air-laid or solid foam substrates;
a front portion of the second paper-based sheet extends beyond the front cellulose-based air-laid or solid foam substrate; and
the front portions of the first paper-based sheet and the front portion of the second paper-based sheet are attached to each other.

11. The packaging insert according to claim 1, wherein
wherein the first paper-based sheet comprises an adhesive coated onto at least a portion of a main side of the first paper-based sheet and attached to the first main sides of the plurality of the cellulose-based air-laid or solid foam substrates with the main side of the first paper-based sheet facing the first main sides of the plurality of the cellulose-based air-laid or solid foam substrates; and
wherein the second paper-based sheet comprises an adhesive coated onto at least a portion of a main side of the second paper-based sheet and attached to the second main sides of the plurality of the multiple cellulose-based air-laid or solid foam substrates with the main side of the second paper-based sheet facing the second main sides of the plurality of the multiple cellulose-based air-laid or solid foam substrates.

12. The packaging insert according to claim 1, wherein the first paper-based sheet and the second paper-based sheets are each selected from a group consisting of: paper sheets, paperboard sheets, paper tissue sheets, and non-woven paper sheets.

13. The packaging insert according to claim 1, wherein the first paper-based sheet and the second paper-based sheets are each selected from a group consisting of: Kraft paper sheets, cardboard sheets, cartonboard sheets, and corrugated board sheets.

14. (canceled)

15. (canceled)

16. The packaging insert according to claim 1, where the plurality of the cellulose-based air-laid or solid foam substrates comprises cellulose-based air-laid substrates.

17.

18. A packaging assembly comprising:
a packaging comprising a bottom and multiple side walls defining a cavity; and
the packaging insert according to claim 1 positioned within the cavity.

19. The packaging assembly according to claim 18, wherein the packaging insert is folded at the at least one hinge section to form at least one corner.

20. The packaging assembly according to claim 18, wherein top portions of the beveled edges of the consecutive cellulose-based air-laid or solid foam substrates (20, 20A, 20B, 20C) are in contact with each other, and
wherein the top portions of the beveled edges are adjacent the first paper-based sheet.

21. The packaging assembly according to claim 18,
wherein the packaging insert,
wherein the angle (α) is within an interval of from 45° up to but not including 90°, and
wherein the packaging insert is folded at the first hinge section and the second hinge section to form a U-shaped packaging insert.

22. A method for producing a packaging insert comprising:
cutting a cellulose-based air-laid or solid foam substrate blank at a first angle (β) of less than 45° relative to a normal of a main side of the cellulose-based air-laid or solid foam substrate blank and at a second angle (β) equal to but of opposite sign to the first angle (β) to obtain a first cellulose-based air-laid or solid foam substrate comprising a beveled edge a second cellulose-based air-laid or solid foam substrate comprising two beveled edges and a third cellulose-based air-laid or solid foam substrate comprising a beveled edge;
turning the second cellulose-based air-laid or solid foam substrate upside down so that the beveled edge of the first cellulose-based air-laid or solid foam substrate faces a first beveled edge of the second cellulose-based air-laid or solid foam substrate and the beveled edge of the third cellulose-based air-laid or solid foam substrate faces a second beveled edge of the second cellulose-based air-laid or solid foam substrate, wherein
the beveled edge of the first cellulose-based air-laid or solid foam substrate and the first beveled edge of the second cellulose-based air-laid or solid foam substrate form an angle (α) between the beveled edges that is less than 90°; and
the beveled edge of the third cellulose-based air-laid or solid foam substrate and the second beveled edge of the second cellulose-based air-laid or solid foam substrate form an angle (α) between the beveled edges that is less than 90°; and
attaching a first paper-based sheet to first main sides of the first cellulose-based air-laid or solid foam substrate, the second cellulose-based air-laid or solid foam substrate, and the third cellulose-based air-laid or solid foam substrates and a second paper-based sheet to second main sides of the first cellulose-based air-laid or solid foam substrate, the second cellulose-based air-laid or solid foam substrate, and the third cellulose-based air-laid or solid foam substrates to form a packaging insert comprising:
a first hinge section interposed between the beveled edge of the first cellulose-based air-laid or solid foam substrate and the first beveled edge of the second cellulose-based air-laid or solid foam substrate; and
a second hinge section interposed between the second beveled edge of the second cellulose-based air-laid or solid foam substrate and the beveled edge of the third cellulose-based air-laid or solid foam substrate.

23. The method according to claim 22, wherein
the first hinge section comprises a wedge-shaped channel defined by the beveled edge of the first cellulose-based air-laid or solid foam substrate and the first beveled edge of the second cellulose-based air-laid or solid foam substrate and the first paper-based sheet and the second paper-based sheets; and
the second hinge section comprises a wedge-shaped channel defined by the second beveled edge of the second cellulose-based air-laid or solid foam substrate and the beveled edge of the third cellulose-based air-laid or solid foam substrate and the first paper-based sheet and the second paper-based sheets.
